(19) United States
(12) Patent Application Publication
(10) Pub. No.: US 2008/0046261 A1
(43) Pub. Date: Feb. 21, 2008

(54) Direct repair program management systems and methods thereof

(75) Inventor: Ian Cunningham, Rochester, NY (US)

Correspondence Address: NIXON PEABODY LLP - PATENT GROUP, CLINTON SQUARE, P.O. BOX 31051, ROCHESTER, NY, 14603-1051, US

(73) Assignee: Scene Genesis, Inc., Pittsford, NY (US)

(21) Appl. No.: 11/505,601

(22) Filed: Aug. 17, 2006

(51) Int. Cl. G06Q 99/00

(52) U.S. Cl. 705/1

(57) ABSTRACT

A method and system for managing a direct repair program includes receiving one or more estimates of repair cost from one or more shops and determining which of the received one or more estimates are in compliance with one or more requirements. The one or more compliant estimates from the one or more shops and stored feedback on the one or more shops associated with the compliant estimates are provided to the source of the claim. A selection of one of the compliant estimates based on the compliant estimates and the stored feedback is received and the claim is awarded to the selected one of the one or more shops.

### FIELD OF THE INVENTION

This invention generally relates to claim management systems and methods and, more particularly, to direct repair program management systems and methods thereof.

### BACKGROUND

The insurance industry has long recognized that a direct repair program is the optimal repair program compared to an indirect repair program because costs are lower and time to repair the collision is quicker. Unfortunately, where the direct repair program breaks down is that a repair shop is rewarded on a higher repair bill because this represents more work and money for the shop. This is directly opposite to the interests of the insurance carrier which wants the repair bill to be as low as possible. As a result, there is an inherent and direct conflict in the interests and motivations of the repair shop and the carrier on the cost of repairing the insured item, such as an automobile.

To resolve this conflict, carriers have contracted with repair shops to provide services at a discounted labor and/or materials rate in exchange for a volume of repair work. These carriers also employ reviews and audits of the repair work to make sure that the shop is adhering to the estimate. Unfortunately, this solution puts the carrier in a predicament in a regulatory environment because the carrier does not want to contract with repair shops in a manner that could be construed as anti-consumer. Additionally, this solution can result in a reduction in quality in the provided repair service. Further, the management and monitoring of these conflicting motivations by the carrier can increase the overall cost so as a consequence this solution is neither economical nor consumer friendly.

### SUMMARY

A method for managing a direct repair program in accordance with embodiments of the present invention includes receiving one or more estimates of repair cost from one or more shops and determining which of the received one or more estimates are in compliance with one or more requirements. The one or more compliant estimates from the one or more shops and stored feedback on the one or more shops associated with the compliant estimates are provided to the source of the claim. A selection of one of the compliant estimates based on the compliant estimates and the stored feedback is received and the claim is awarded to the selected one of the one or more shops.

A computer readable medium having stored thereon instructions for managing a direct repair program in accordance with other embodiments of the present invention includes receiving one or more estimates of repair cost from one or more shops and determining which of the received one or more estimates are in compliance with one or more requirements. The one or more compliant estimates from the one or more shops and stored feedback on the one or more shops associated with the compliant estimates are provided to the source of the claim. A selection of one of the compliant estimates based on the compliant estimates and the stored feedback is received and the claim is awarded to the selected one of the one or more shops.

A direct repair program management system in accordance with other embodiments of the present invention includes a communication system that receives one or more estimates of repair cost from one or more shop management systems and a management processing system that determines which of the received one or more estimates are in compliance with one or more requirements. The communication system provides the one or more compliant estimates and stored feedback on the one or more shop management systems associated with the one or more compliant estimates to a claim source system and receives a selection of one of the one or more compliant estimates based on the one or more compliant estimates and the stored feedback. The management processing system awards the claim to the selected one of the one or more shop management systems.

The present invention provides a number of advantages including providing a more effective and efficient system and method for managing a direct repair program. With the present invention, the consumer is the decision maker as to which shop makes the repair and thus has more ownership in and consequently more satisfaction with the repair process. Additionally, with the present invention the conflicting motivations of the repair shops and carrier to otherwise push the estimate higher or lower are balanced by having an accurate estimate provided by an appraiser. Further, with the present invention an estimated time for completion is provided with the estimates received from the repair shops to ensure prompt and reliable service. Even further, the present invention provides and stores feedback based on the repair work of each of the repair shops which provides a powerful and inexpensive motivator for the repair shops to provide top, service to consumers.

### BRIEF DESCRIPTION OF THE DRAWINGS

FIG. 1 is a block diagram of a direct repair program management system in accordance other embodiments of the present invention; and

FIG. 2 is a flow chart of the management of a direct repair program in accordance with embodiments of the present invention.

### DETAILED DESCRIPTION

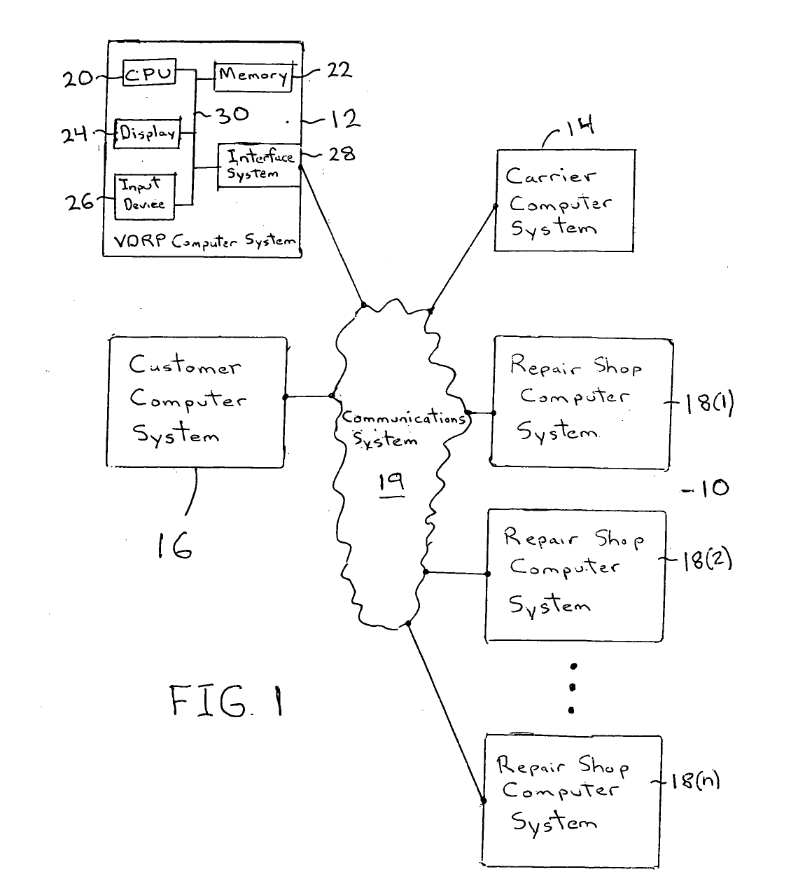

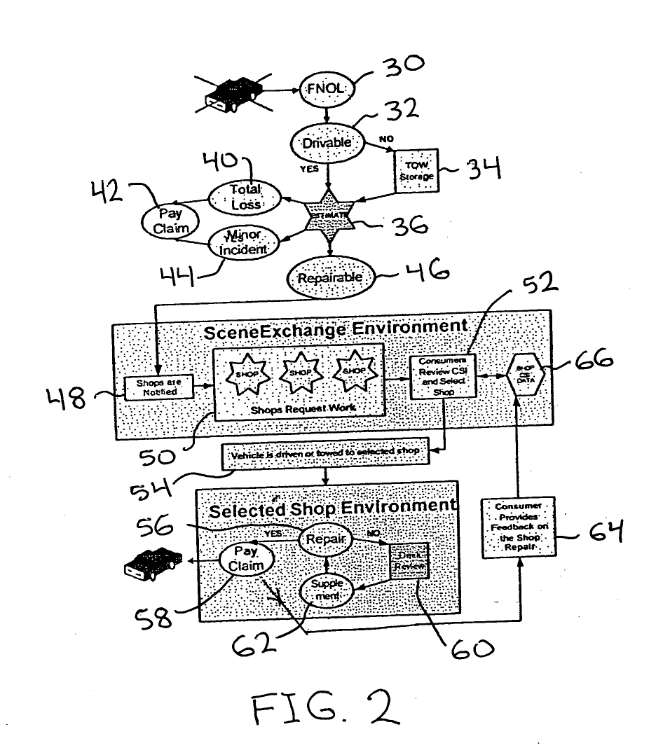

A system for managing a direct repair program 10 in accordance other embodiments of the present invention is illustrated in FIGS. 1 and 2. The system 10 includes a virtual direct repair program (VDRP) computer system 12, at least one carrier computer system 14, at least one customer computer system 16, and a plurality of repair shop computer systems 18(1)-18(n), although the system 10 can comprise other numbers and types of systems and components in other configurations.

The present invention provides a number of advantages including providing a more effective and efficient system and method for managing a direct repair program. By way of example only, the structure and operation of embodiments of the present invention is described herein with reference to managing the direct repair of automobiles, although the present invention can be used to manage other types of insurance claims for other types of systems and devices, such as for homes, and can also be used in other types of settings. Additionally, in the description herein, the insured customer can be substituted by the insured customer's agent or broker or the insurance carrier's designated representative.

Referring more specifically to FIG. 1, the virtual direct repair program computer system 12 manages a direct repair program between the carrier computer system 14, the customer computer system 16, and the repair shop computer systems 18(1)-18(n), although the virtual direct repair program computer system 12 can manage other systems and have other functions. The virtual direct repair program computer system 12 comprises a central processing unit (CPU) or processor 20, a memory 22, a display system 24, an input device 26, and an interface system 28 which are coupled together by a bus or other link 30, although the virtual direct repair program computer system 12 can comprise other numbers and types of each of the components and other configurations and locations for each of the components can be used.

The processor 20 executes a program of stored instructions for one or more aspects of the present invention as described and illustrated herein, including the method for managing a direct repair program, although the processor 20 could execute other types of programmed instructions. The memory 22 stores these programmed instructions for one or more aspects of the present invention as described herein, although some or all of the programmed instructions could be stored and/or executed elsewhere, such as in the carrier system 14, the customer computer system 16, and/or the repair shop computer systems 18(1)-18(n). A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to one of the processor 20, can be used for the memory 22.

The display system 24 displays information to an operator, such as the received estimates with the estimated time for completion, images of the damage, or information relating to a request for supplementation of the estimate by way of example only. The display system 24 comprises a computer monitor and also includes a standard browser based system, although other numbers and types of displays in other configurations can be used. The input device 26 enables an operator to access and interact with the virtual direct repair program computer system 12. The input device 26 comprises a computer keyboard, although other types and numbers of input devices in other configurations could be used, such as a computer mouse.

The interface system 28 is used to operatively couple and communicate between the virtual direct repair program computer system 12 and the carrier system 14, the customer computer system 16, and the repair shop computer systems 18(1)-18(n) via communications system 19, although other types and numbers of connections and other configurations could be used. The communication system 19 comprises the Internet, although other types and numbers of communication systems, such as a local area network, a wide area network, modems and phone lines, e-mails, and/or wireless communication technology each having their own communications protocols, could be used.

The carrier computer system 14 is used by an insurance carrier to process claims for repair claims submitted by insured customers and to manage repairs with repair shops, although the carrier computer system 14 could have other functions and other numbers and types of carrier processing systems by other numbers of insurance carriers could be used. The carrier computer system 14 includes a central processing unit (CPU) or processor, a memory, a display system, an input device, and an interface system which are coupled together by a bus or other link, although other numbers and types of each of the components and other configurations and locations for the components can be used. The processor in the carrier computer system 14 executes a program of stored instructions for one or more aspects of the present invention as described herein including receiving and processing claims from insured customers, providing estimates with images of damage reported in a claim, managing repair shops, and interacting with the virtual direct repair program computer system 12. The memory stores these programmed instructions for one or more aspects of the present invention as described herein, although some or all of the programmed instructions could be stored and/or executed elsewhere, such as in one or memories of provider systems. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory in the carrier computer system 14. The display system displays information to an operator, such as the received claim, an estimate for the repair in the claim along with one or more images of the damage to the automobile, the received estimates for repairing the automobile with the estimated time for completion, and information relating to a request for supplementation of the estimate by way of example only. The display system in the carrier computer system 14 comprises a computer monitor and also includes a standard browser based system, although other numbers and types of displays in other configurations can be used. The input device enables an operator to interact with the carrier computer system 14 and comprises a computer keyboard, although other types and numbers of input devices in other configurations could be used, such as a computer mouse. The interface system in the carrier computer system 14 is used to operatively couple and communicate between the carrier computer system 14 and the virtual direct repair program computer system 12, the customer computer system 16, and the repair shop computer systems 18(1)-18(n).

The customer computer system 16 is used by an insurance customer to submit a claim to the carrier and to review repair estimates with estimated times for completion from repair shops and feedback on those repair shops, and to select a repair offer and provide subsequent feedback on the selected repair shop, although the customer computer system 16 could have other functions and other numbers and types of computer processing systems by other numbers of customers can be used. The customer computer system 16 includes a central processing unit (CPU) or processor, a memory, a display system, an input device, and an interface system which are coupled together by a bus or other link, although other numbers and types of each of the components and other configurations and locations for the components can be used. The processor in the customer computer system 16 executes a program of stored instructions for one or more aspects of the present invention as described herein including submitting a claim, receiving and reviewing repair estimates and feedback on the repair shops submitting estimates, and selecting a repair offer and providing feedback on the selected repair shop. The memory stores these programmed instructions for one or more aspects of the present invention as described herein, although some or all of the programmed instructions could be stored and/or executed elsewhere, such as in one or memories of provider systems. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory in the customer computer system 16. The display system displays information to an operator, such as the submitted claim and the received estimates with the estimated time for completion and feedback on the repair shops submitting repair estimates by way of example only. The display system in the customer computer system 16 comprises a computer monitor and also includes a standard browser based system, although other numbers and types of displays in other configurations can be used. The input device enables an operator to interact with the carrier computer system 14 and comprises a computer keyboard, although other types and numbers of input devices in other configurations could be used, such as a computer mouse. The interface system in the customer computer system 16 is used to operatively couple and communicate between the customer computer system 16 and the virtual direct repair program computer system 12, the carrier computer system 14, and the repair shop computer systems 18(1)-18(n).

Each of the repair shop computer systems 18(1)-18(n) is used by the repair shops to receive and review estimates and images of damage reported in a repair claim, prepare and submit repair estimates with an estimated time of completion, request supplementation of the estimate when necessary, and provide at least notification of payment when selected for participating in this program, although each of the repair shop computer systems 18(1)-18(n) could have other functions and other numbers and types of processing systems can be used. Each of the repair shop computer systems 18(1)-18(n) includes a central processing unit (CPU) or processor, a memory, a display system, an input device, and an interface system which are coupled together by a bus or other link, although other numbers and types of each of the components and other configurations and locations for the components can be used. The processor in each of the repair shop computer systems 18(1)-18(n) executes a program of stored instructions for one or more aspects of the present invention as described herein including receiving and reviewing estimates and images of damage in a repair claim, preparing and submitting repair estimates with an estimated time of completion, requesting supplementation of the estimate when necessary, and providing at least notification of payment when selected for participating in this program. The memory stores these programmed instructions for one or more aspects of the present invention as described herein, although some or all of the programmed instructions could be stored and/or executed elsewhere, such as in one or memories of provider systems. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to the processor, can be used for the memory in each of the repair shop computer systems 18(1)-18(n). The display system displays information to an operator, such as the received claim with images of the damage to be repaired and notification of selection to handle a repair the estimate by way of example only. The display system in each of the repair shop computer systems 18(1)-18(n) comprises a computer monitor and also includes a standard browser based system, although other numbers and types of displays in other configurations can be used. The input device in the each of the repair shop computer systems 18(1)-18(n) enables operators to interact with each of the repair shop computer systems 18(1)-18(n) and comprises a computer keyboard, although other types and numbers of input devices in other configurations could be used, such as a computer mouse. The interface system in each of the repair shop computer systems 18(1)-18(n) is used to operatively couple and communicate between each of the repair shop computer systems 18(1)-18(n) and the virtual direct repair program computer system 12, the carrier computer system 14, and the customer computer system 16.

Although the system 10 is described and illustrated herein as implemented in the virtual direct repair program computer system 12, a carrier computer system 14, a customer computer system 16, and a plurality of repair shop computer systems 18(1)-18(n), the present invention can be implemented in other numbers and types of systems can be used, such as multiple customer computer systems and multiple carrier computer systems, and in other configurations. Each of the systems of the present invention may be implemented on any suitable computer system, server, or other computing device. It is to be understood that the devices and systems of the exemplary embodiments are for exemplary purposes, as many variations of the specific hardware used to implement the exemplary embodiments are possible, as will be appreciated by those skilled in the relevant art(s).

Furthermore, each of the systems of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing systems or devices can be substituted for any one of the systems in any embodiment of the present invention. Accordingly, principles and advantages of distributed processing, such as redundancy, replication, and the like, also can be implemented, as desired, to increase the robustness and performance of the devices and systems of the exemplary embodiments. The present invention may also be implemented on computer systems that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for generating a model for simulating systems of reacting species, which when executed by a processor, cause the processor to carry out the steps necessary to implement the methods of the present invention. The computer readable medium may also include programmed instructions for carrying out any of the other steps described and illustrated herein with respect to the methods of the present invention.

The operation of the system 10 will now be described with reference to FIGS. 1-2. In step 30, the carrier at carrier computer system 14 receives a first notice of loss and a claim from an insured customer using customer computer system 16 to submit a claim, although other manners for submitting a claim or notifying the insurance carrier can be used. When the carrier computer system 14 receives the claim, the carrier computer system 14 notifies the virtual direct repair program computer system 12 who arranges for an appraiser to meet with the insured customer.

In step 32, a determination is made whether the automobile is drivable by the insured customer, although others could make this determination. If the automobile is not drivable, then the No branch is taken from step 32 to step 34 where the automobile is towed to the appraiser and then to step 36 although the automobile can be towed to other locations or serviced in other manners. If the automobile is drivable, then in step 32 the Yes branch is taken to step 36 and either the appraiser can arrange to go out and meet the insured customer or the insured customer can drive to the office location of the appraiser.

In step 36, the appraiser determines the severity of the claim. If in step 36 the appraiser determines the automobile is a total loss, e.g. losses approaching 80% of the value of the automobile, then the claim is recorded in step 40 as a total loss by the virtual direct repair program computer system 12. Next, in step 42 the carrier processing system 14 is notified by the virtual direct repair program computer system 12 that the claim is a total loss and is instructed to pay the appraised amount for the claim to the insured customer.

If in step 36 the appraiser determines this is a minor claim, e.g. a low value claim or glass claim, then the claim is recorded in step 44 as a minor claim or incident by the virtual direct repair program computer system 12. Next, in step 42 the carrier processing system 14 is notified by the virtual direct repair program computer system 12 that the claim is a minor incident and is instructed to pay the appraised amount for the claim to the insured customer.

If in step 36 the appraiser determines the automobile is not a total loss or a minor incident and the automobile can be repaired, then in step 46 the claim is recorded as repairable by the virtual direct repair program computer system 12. Additionally, in step 46 the virtual direct repair program computer system 12 receives a cost for repairing the automobile along with one or more images of the automobile to illustrate the damage and prepares an estimate with the images of the damage for distribution to participating repair shops via one or more of the repair shop computer systems 18(1)-18(n) for estimates, although other manners for distributing the estimate and/or images can be used and other types of information can be provided with the estimate.

Next, in step 48, the virtual direct repair program computer system 12 submits the estimate with the one or more images of the damage to participating repair shops via one or more of the repair shop computer systems 18(1)-18(n). The virtual direct repair program computer system 12 may also set a time period in which the participating repair shops via one or more of the repair shop computer systems 18(1)-18(n) have for submitting an offer for making the repair in accordance with the terms of the estimate, such as a two day period of time from the distribution or positing of the estimate for the claim.

In step 50, one or more of the repair shops at shop computer systems 18(1)-18(n) review the estimate from the virtual direct repair program computer system 12 and submit estimates for completing the repair for a cost set forth in the estimate and with an estimated time of completion, although other types of information could be included in the estimates from the repair shops and other manners for providing the estimates can be used. The virtual direct repair program computer system 12 receives the estimates for making the repair, from one or more repair shops via one or more of the repair shop computer systems 18(1)-18(n) and determines if the received estimates satisfy the initial conditions of the estimate, e.g. the received estimates accept the payment for making the repair in the claim and will make the repair within an acceptable time range, although other types and number of criteria can be used. The received estimates which are determined to be satisfy the one or more criteria established by the virtual direct repair program computer system 12 are provided to the insured customer at customer computer system 16, although other manners for providing the acceptable estimates to the insured customer can be used and the received offer can be provided to others, such as or the insured customer's agent or broker or the insurance carriers' designated representative.

In step 52, the insured customer at customer computer system 16 reviews the received estimates for making the repair, although others could review the received estimates, such as the insured customer's agent or broker or the insurance carriers' designated representative. Additionally, the insured customer at customer computer system 16 can also request and review feedback on each of the repair shops from prior customers from memory 22 of the virtual direct repair program computer system 12, although the feedback can be stored and retrieved from other locations and can be accessed and reviewed by others, such as the insured customer's agent or broker or the insurance carriers' designated representative. By having access to and reviewing the feedback, the insured customers have more control and a greater sense of satisfaction and control of the repair process. Additionally, the stored feedback on each of the repair shops provides a strong incentive for the repair shops to provide the highest quality work and service to the insured customer or to the insured customer's agent or broker or the insurance carriers' designated representative.

Next, in step 54 the insured customer at customer computer system 16 selects the repair offer from one of the repair shops and this selection is sent to the virtual direct repair program computer system 12 which then notifies the selected one of the repair shops via the corresponding one of the repair shop computer systems 18(1)-18(n), although the selection can be processed in and the notification can be provided in other manners and other can make the selection, such as the insured customer's agent or broker or the insurance carriers' designated representative. Once one of the repair shops at one of repair shop computer systems 18(1)-18(n) is selected, the selected repair shop transmits at least a notice of a first payment, by way of example only $100, to the virtual direct repair program computer system 12 as payment for being selected, although other types and manners for receiving payment from the repair shops for participation in this process can be used, such as an annual fee payment by way of example only. Additionally, the insured customer via customer system 16 sets a date and time to drop off the automobile at the selected repair shop at the corresponding one of the repair shop computer systems 18(1)-18(n), such as with a calendaring program which is well known to those of ordinary skill in the art, although other manners for scheduling the repair can be used and other can scheduled the date and time, such as the insured customer's agent or broker or the insurance carriers' designated representative. Based on the drop off date, the estimated time for completion provided by the selected repair shop is used by the virtual direct repair program computer system 12 to set the completion date which is transmitted to the insured customer at the customer computer system 16, although other manners for providing the completion date can be used and the completion date can be sent to others, such as the insured customer's agent or broker or the insurance carriers' designated representative. Further, if the insured customer has rental car coverage, then once the drop off date is set, the virtual direct repair program computer system 12 notifies the rental car company who then meets the insured customer at the selected repair shop with the rental car, although other manners for arranging rental car coverage can be used. With other embodiments of the present invention, the insured customer can also select other services associated with the automobile or other property damage claims which is being covered, in addition to selecting a rental car.

In step 56, the selected one of the repair shops makes the repair to the automobile. If the repair is not going to be completed by the set completion date, then the repair shop via one of the repair shop computer systems 18(1)-18(n) notifies the virtual direct repair program computer system 12 which notifies the insured customer at the customer computer system 16, although other manners for providing the notification can be used and other can be notified, such as the insured customer's agent or broker or the insurance carriers' designated representative. The repair shop via one of the repair shop computer systems 18(1)-18(n) sets a new completion date for the repair which must be confirmed by the insured customer at the customer computer system 16 and is recorded by the virtual direct repair program computer system 12, although can confirm the date, such as the insured customer's agent or broker or the insurance carriers' designated representative. Additionally, if the customer has a rental car, the virtual direct repair program computer system 12 notifies the rental car company and obtains any necessary extensions in accordance with the insurance policy of the insured customer.

If the repair is completed in step 56, then the insured customer at customer computer system 16 is notified by the repair shop via one of the repair shop computer systems 18(1)-18(n) by phone or email, although other manners for providing this notification can be used and others can be notified, such as the insured customer's agent or broker or the insurance carriers' designated representative. Additionally, once the repair is completed, the Yes branch is taken to step 58 where the selected one of the repair shop computer systems 18(1)-18(n) notifies the virtual direct repair program computer system 12. The virtual direct repair program computer system 12 notifies the insurance carrier at carrier computer system 14 which transmits at least a notice of a payment of the amount in the estimate for the claim to the selected one of the repair shop computer systems 18(1)-18(n), although other manners for providing the notification of completion and for arranging and making payment to the repair shop which made the repair can be used.

If the repair is not completed in step 56 because of the discovery that additional work and/or parts are required to make the repair, then the No branch is taken to step 60. In step 60, the selected one of the repair shop computer systems 18(1)-18(n) notifies the virtual direct repair program computer system 12 of the additional work required along with information on what additional work and/or parts are required. The virtual direct repair program computer system 12 may gather additional information, such as with another review by the appraiser, and then makes a determination in step 62 on whether to grant a supplemental payment and then returns to step 56.

Once the repair is completed in step 56, the insured customer at customer computer system 16 is notified by the repair shop via one of the repair shop computer systems 18(1)-18(n) by phone or email, although other manners for providing this notification can be used and others can be notified, such as the insured customer's agent or broker or the insurance carriers' designated representative.

Next, in step 64 the insured customer at customer computer system 16 can provide feedback on the selected repair shop, although others can provide feedback, such as the insured customer's agent or broker or the insurance carriers' designated representative. The repair shop via one of the repair shop computer systems 18(1)-18(n) has the option of responding to any stored feedback. This feedback and any response to the feedback is stored in memory 22 of virtual direct repair program computer system 12 for review by future insurance customers submitting claims, although the feedback could be stored at other locations.

Accordingly, the present invention provides a more effective and efficient system and method for managing a direct repair program. With the present invention, insured customers, the insured customer's agent or broker, and/or the insurance carriers' designated representative are able to actively participate in the repair process and benefit from the feedback of other insured customers and thus have a much higher level of satisfaction with the process. Additionally, with the present invention repair shops are motivated to provide the highest level of service to be able to receive a high volume of future work. Further, with the present invention insurance carriers are able to effectively manage the insurance process with high levels of customer satisfaction, with reasonable costs, and without concern for allegations of collusion with repair shops.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing a direct repair program, the method comprising:
receiving one or more estimates of repair cost for damage reported in a claim from one or more shops;
determining which of the received one or more estimates are in compliance with one or more requirements;
providing the one or more compliant estimates and stored feedback on the one or more shops associated with the compliant estimates to the source of the claim;
receiving a selection of one of the compliant estimates based on the compliant estimates and the stored feedback; and
awarding the claim to the selected one of the one or more shops.

2. The method as set forth in claim 1 further comprising providing the estimate for the claim to one or more shops.

3. The method as set forth in claim 2 wherein the provided estimate includes one or more images of the damage reported in the claim.

4. The method as set forth in claim 1 wherein the receiving one or more estimates further comprises:
receiving an estimated time for completion of the claim for each of the one or more compliant estimates; and
providing the received estimated time for completion for each of the one or more compliant estimates to the source of the claim;
wherein the receiving a selection of one of the one or more compliant estimates is further based on the received estimated time for completion for each of the one or more compliant estimates.

5. The method as set forth in claim 1 further comprising receiving at least notification of payment of a first compensation from the one of the one or more shops awarded the claim.

6. The method as set forth in claim 1 further comprising:
receiving new feedback from the source of the claim on the selected one of the one or more shops; and
storing the new feedback in the stored feedback.

7. The method as set forth in claim 1 further comprising:
receiving a request for a supplement to the estimate from the one of the one or more shops awarded the claim;
determining whether the request for the supplement is needed; and
outputting the determination on the supplement to the one of the one or more shops awarded the claim.

8. The method as set forth in claim 1 further comprising:
receiving notification when work on the claim is completed by the one of the one or more shops awarded the claim; and
providing at least notification of payment of the estimate to the one of the one or more shops awarded the claim based on the received notification.

9. A computer readable medium having stored thereon instructions for managing a direct repair program comprising machine executable code which when executed by at least one processor, causes the processor to perform steps comprising:
receiving one or more estimates of repair cost for damage reported in a claim from one or more shops;
determining which of the received one or more estimates are in compliance with one or more requirements;
providing the one or more compliant estimates and stored feedback on the one or more shops associated with the compliant estimates to the source of the claim;
receiving a selection of one of the one or more compliant estimates based on the one or more compliant estimates and the stored feedback; and
awarding the claim to the selected one of the one or more shops.

10. The computer readable medium as set forth in claim 9 further comprising providing the estimate for the claim to one or more shops.

11. The computer readable medium as set forth in claim 10 wherein the provided estimate includes one or more images of the damage reported in the claim.

12. The computer readable medium as set forth in claim 9 wherein the receiving one or more estimates further comprises:
receiving an estimated time for completion of the claim for each of the one or more compliant estimates; and
providing the received estimated time for completion for each of the one or more compliant estimates to the source of the claim;
wherein the receiving a selection of one of the one or more compliant estimates is further based on the received estimated time for completion for each of the one or more compliant estimates.

13. The computer readable medium as set forth in claim 9 further comprising at least notification of payment of a first compensation from the one of the one or more shops awarded the claim.

14. The computer readable medium as set forth in claim 9 further comprising:
receiving new feedback from the source of the claim on the selected one of the one or more shops; and
storing the new feedback in the stored feedback.

15. The computer readable medium as set forth in claim 9 further comprising:
receiving a request for a supplement to the estimate from the one of the one or more shops awarded the claim;
determining whether the request for the supplement is needed; and
outputting the determination on the supplement to the one of the one or more shops awarded the claim.

16. The computer readable medium as set forth in claim 9 further comprising:
receiving notification when work on the claim is completed by the one of the one or more shops awarded the claim; and
providing at least notification of payment of the estimate to the one of the one or more shops awarded the claim based on the received notification.

17. A direct repair program management system comprising:
a communication system that receives one or more estimates of repair cost for damage reported in a claim from one or more shop management systems; and
a management processing system that determines which of the received one or more estimates are in compliance with one or more requirements;
wherein the communication system provides the one or more compliant estimates from the one or more shop management systems and stored feedback on the one or more shop management systems associated with the one or more compliant estimates to a claim source system and receives a selection of one of the one or more compliant estimates based on the one or more compliant estimates and the stored feedback;
wherein the management processing system awards the claim to the selected one of the one or more shop management systems.

18. The system as set forth in claim 17 wherein the communication system provides the estimate for the claim to one or more shop management systems.

19. The system as set forth in claim 18 wherein the provided estimate includes one or more images of the damage reported in the claim.

20. The system as set forth in claim 17 wherein the communication system receives an estimated time for completion of the claim for each of the one or more compliant estimates and provides the received estimated time for completion for each of the one or more compliant estimates to the claim source system, wherein the received selection of one of the one or more compliant estimates is further based on the received estimated time for completion for each of the one or more compliant estimates.

21. The system as set forth in claim 17 wherein the communication system receives at least at least notification of payment of a first compensation from the one of the one or more shop management systems awarded the claim.

22. The system as set forth in claim 17 wherein the communication system receives new feedback from the source of the claim on the selected one of the one or more shop management systems and the management processing system stores the new feedback in the stored feedback.

23. The system as set forth in claim 17 wherein the communication system receives a request for a supplement to the estimate from the one of the one or more shop management systems awarded the claim, the management processing system determines whether the request for the supplement is needed, and the communication system outputs the determination on the supplement to the one of the one or more shop management systems awarded the claim.

24. The system as set forth in claim 17 wherein the communication system receiving notification when work on the claim is completed by the one of the one or more shop management systems awarded the claim and provides at least notification of payment of the estimate to the one of the one or more shop management systems awarded the claim based on the received notification.
